(19) United States
(12) Patent Application Publication
(10) Pub. No.: US 2006/0045572 A1
(43) Pub. Date: Mar. 2, 2006

(54) Liquid-developing electrophotographic apparatus

(76) Inventors: Hironaga Hongawa, Ishikawa (JP); Kazuto Yamanada, Ishikawa (JP)

Correspondence Address: STAAS & HALSEY LLP, SUITE 700, 1201 NEW YORK AVENUE, N.W., WASHINGTON, DC, 20005, US

(21) Appl. No.: 10/533,064

(22) PCT Filed: Apr. 23, 2004
(86) PCT No.: PCT/JP04/05949

§ 371 Date: Apr. 28, 2005

(30) Foreign Application Priority Data
May 1, 2003 (JP) 2003-126432

(51) Int. Cl. G03G 15/10

(52) U.S. Cl. 399/237; 399/249

(57) ABSTRACT

A liquid-development electrophotographic apparatus of the present invention uses a nonvolatile liquid developer. An electric field force causes toner to adhere to an electrostatic latent image formed on a photoconductive member 2 to thereby form a toner image on the photoconductive member 2. Viscoelasticity control means is provided for controlling the viscoelasticity of a toner image transferred from the photoconductive member 2 onto an intermediate transfer member 3. A temperature of the liquid toner at which a predetermined requirement for a dynamic viscoelastic value is satisfied is obtained beforehand by preliminary measurement. The viscoelasticity control means controls heating by a heater 4, which serves as heating means, in such a manner that the toner image on the intermediate transfer member 3 is heated to the temperature before being transferred onto a printing medium 6. A carrier-agent-removing roller 7 of reverse rotation is provided for removing a carrier agent from the toner image whose viscoelasticity has been controlled.

### TECHNICAL FIELD

The present invention relates to a liquid-development electrophotographic apparatus that uses a liquid developer, and provides a liquid-development electrophotographic apparatus that, when a melt transfer process is employed for transferring a toner image formed on an image-bearing member, such as a photoconductive member or an intermediate transfer member, to a printing medium, can print with high image quality by controlling the viscosity of the liquid developer to an optimum viscoelastic characteristic value without need to apply an excessively high pressure in the course of transfer of the toner image onto the printing medium.

### BACKGROUND ART

An electrophotographic apparatus that uses a liquid developer has employed an electrostatic transfer process for transferring a toner image onto a printing medium, such as paper. In the electrostatic transfer process, bias voltage is applied to a toner image formed on an image-bearing member to thereby transfer the toner onto the printing medium. However, since such electrostatic transfer is influenced by the electric resistance of the printing medium, printing quality greatly depends on environmental conditions, such as temperature and humidity. Accordingly, the environmental specifications of a printer system include restrictive environmental conditions.

In order to solve such a problem, a melt transfer process is proposed. In the melt transfer process, before transfer of a toner image onto a printing medium, toner particles (solid component) are melted by application of heat; and the adhesive force of the molten toner solid component is utilized for transfer onto the printing medium.

As shown in FIG. 12, according to the conventional process, developing units 51 corresponding to a plurality of colors cause, by utilization of electric field force, toner particles in the corresponding colors to adhere to corresponding electrostatic latent images formed on a photoconductive member 50, thereby forming a toner image on the photoconductive member 50. Before the toner image is transferred onto a printing medium 53, the toner image particles are melted by application of heat from a heater 54 contained in the photoconductive member 50. In a transfer section, a backup roller 52 causes the molten toner image particles to be pressed against the printing medium 53 for transfer onto the printing medium 53.

In the case where such a melt transfer process uses a volatile liquid developer, sufficient adhesive force required for transfer of a toner image onto a printing medium can be secured without weakening of the cohesive force of the molten toner image particles, since a carrier agent contained in the liquid developer volatilizes before transfer of the toner image. However, in the case where such a volatile liquid developer is used, a large-scaled volatile-solvent collection system must be employed in order to prevent a volatilized carrier agent from affecting the body of a user of the electrophotographic apparatus.

In the case where a nonvolatile liquid developer is used, a carrier agent contained in the liquid developer weakens the cohesive force of the molten toner image particles. In order to cope with the problem, as shown in FIG. 2(C), the toner particles are completely melted into a liquefied condition to thereby forcibly expel the carrier agent from inter-toner-particle spacing for removal. However, as a result of the toner particles being melted, an adhesive force generated by the toner particles themselves fails to be sufficiently utilized for transfer, resulting in a failure to secure sufficient adhesive force required for transfer of a toner image onto a printing medium. Thus, in order to compensate for a weakened cohesive force of toner image particles for obtaining sufficient adhesive force, for use in a conventional electrophotographic apparatus that uses a nonvolatile liquid developer and employs a melt transfer process, there is proposed an apparatus in which a backup roller applies excessively high pressure in the course of transfer of the toner image onto a printing medium (refer to, for example, Japanese Patent Application Laid-Open (kokai) No. 2002-311725).

However, in some cases, such an apparatus in which the backup roller applies excessively high pressure in the course of transfer involves the following problem: when a printing medium is fed into a contact region between an image-bearing member and the backup roller, vibration is generated in the apparatus, thereby causing generation of an image noise called a “shock mark” and thus hindering printing with high image quality.

### DISCLOSURE OF THE INVENTION

As described above, the prior art techniques involve the following problem.

An electrophotographic apparatus that uses a liquid developer has employed an electrostatic transfer process, in which electric field force is applied so as to cause the movement of toner particles toward a printing medium in the course of transfer of a toner image from an image-bearing member onto the printing medium. However, the electrostatic transfer is apt to involve a defective transfer onto the printing medium, depending on working environmental conditions, particularly working temperature and humidity, of the electrophotographic apparatus, resulting in a hindrance to printing with high image quality.

In order to solve the above problem, a melt transfer process is proposed. In the melt transfer process, toner particles, which are a solid component contained in the liquid developer, are melted by application of heat so as to utilize the adhesive force of the toner particles themselves for transfer onto a printing medium. However, in the case of an electrophotographic apparatus using a nonvolatile liquid developer, even when toner particles, which are a solid component contained in the liquid developer, are melted, a carrier agent, which is a liquid component contained in the liquid developer, weakens the cohesive force of the toner image particles; as a result, in some cases, an adhesive force generated as a result of the toner particles being melted is insufficient for satisfactory transfer of the toner image onto a printing medium.

In order to solve the above problem, there is proposed an apparatus in which, in the course of transfer of a toner image onto a printing medium, a backup roller applies excessively high pressure so as to compensate for a carrier-agent-weakened cohesive force of toner image particles. However, such an apparatus in which excessively high pressure is applied in the course of transfer of a toner image onto a printing medium involves the following problem: when the printing medium is fed into an image transfer section, vibration is generated in the apparatus, thereby causing generation of noise called a “shock mark” and thus hindering image quality.

An object of the present invention is to provide an electrophotographic apparatus that uses a nonvolatile liquid developer and can completely transfer a toner image onto a printing medium, without need to apply an excessively high pressure, by use of a melt transfer process, in which toner particles, which are a solid component contained in the liquid developer, are melted for transfer onto the printing medium, thereby enabling printing with high image quality free from generation of noise, such as a shock mark.

A liquid-development electrophotographic apparatus of the present invention performs transfer in such a manner that a toner image formed by developing a formed electrostatic latent image by use of a nonvolatile liquid developer is transferred from an image-bearing member onto a printing medium by a melt transfer process. The liquid-development electrophotographic apparatus comprises control means for controlling the viscoelasticity of a toner image on the image-bearing member by bonding toner particles of the toner image together by means of partially melting the toner particles, so as to cause the liquid toner to enter a liquid-toner-softened condition having a carrier agent in inter-bonded-toner-particle spacing. The control means causes the toner particles to be bonded together without causing the toner particles to be melted to such an extent as to be liquefied, and causes the bonded toner particles to be separated from the carrier agent. The liquid-development electrophotographic apparatus further comprises carrier-agent-removing means for removing the carrier agent from the viscoelasticity-controlled toner image. The carrier-agent-removing means has a surface in contact with the carrier agent caused to float by use of electric field force, and removes the carrier agent by moving the surface in a direction opposite a moving direction of the toner image.

The viscoelasticity of the toner image is controlled such that, when the dynamic viscoelasticity of the toner image is measured at a forced vibration frequency of 1 Hz and an amplitude stress of 10 Pa, a storage modulus falls within a range of 1.0E5 Pa to 1.0E8 Pa, and a loss modulus falls within a range of 1.0E5 Pa to 1.0E8 Pa.

A temperature of the liquid toner at which the above-mentioned requirement for a dynamic viscoelastic value is satisfied is obtained beforehand by preliminary measurement. The viscoelasticity control means can assume the form of means for heating the toner image on the image-bearing member to the obtained temperature.

A carrier agent can be removed immediately before transfer of the toner image onto a printing medium as described below. While control is performed so as to satisfy the above-mentioned requirement for the dynamic viscoelasticity of the toner image on the image-bearing member, bias voltage having the same polarity as that of a charge established on the toner is applied to the toner image so as to impose electric field force on the toner in such a direction as to press the toner against the image-bearing member, thereby causing the carrier agent to float on the toner. The floating carrier agent is removed by means of a moving member that moves at a speed equal to or higher than the moving speed of the toner image on the image-bearing member in a direction opposite the moving direction of the toner image. Furthermore, within 2,000 ms after the removal of the floating carrier agent, the toner image is transferred onto the printing medium.

In order to maintain the condition in which the above-mentioned requirement for the dynamic viscoelasticity of the toner image is satisfied, heating the toner image on the image-bearing member by the heating means may be controlled in such a manner that the temperature of the image-bearing member becomes not higher than the boiling point of the carrier agent and not higher than 100° C.

Preferably, while the above-mentioned requirement for the dynamic viscoelasticity of the toner image is satisfied, the carrier agent is removed in such a manner that, before the toner image is transferred onto the printing medium, the solid content of the toner image on the image-bearing member is 50% to 95%.

Preferably, while the above-mentioned requirement for the dynamic viscoelasticity of the toner image is satisfied, a pressure to be applied in the course of transfer of the toner image onto the printing medium is controlled to 0.5 MPa to 4.0 MPa.

In the case of color printing in which toner images whose dynamic viscoelasticity satisfies the above-mentioned requirement are superposed on each other on the image-bearing member, the carrier agent can be removed each time a toner image in each of a plurality of colors is transferred onto the image-bearing member, by means of a moving member that moves at a speed equal to the moving speed of the image-bearing member in the same direction as the moving direction of the image-bearing member.

When the toner image whose dynamic viscoelasticity satisfies the above-mentioned requirement is to be transferred onto the printing medium, the printing medium can be heated beforehand to not higher than [(the lowest temperature at which the dynamic viscoelasticity is such that the storage modulus is 1.0E5 Pa or less, and the loss modulus is 1.0E5 Pa or less)+50° C.].

When the toner image whose dynamic viscoelasticity satisfies the above-mentioned requirement is to be transferred onto the printing medium, bias voltage can be applied in such a direction as to cause the toner image to move toward the printing medium.

### BRIEF DESCRIPTION OF THE DRAWINGS

FIG. 1 is a view exemplifying an electrophotographic apparatus using a nonvolatile liquid developer and transferring a toner image onto a printing medium by a melt transfer process;

FIG. 2 is a series of explanatory views showing a liquid toner in different molten conditions;

FIG. 3 is a pair of explanatory views showing a process for removing unnecessary carrier agent;

FIG. 4 is an explanatory view showing the relationship between a carrier-agent-removing process and a position of transfer onto a printing medium;

FIG. 5 is an explanatory view showing re-dispersion of toner solid after removal of a carrier agent;

FIG. 6 is a pair of explanatory views showing a process for removing a carrier agent each time a color toner image in each color is transferred;

FIG. 7 a pair of explanatory views showing the effect of a carrier-agent-removing process in color printing;

FIG. 8 is an explanatory view showing application of pressure by a backup roller in the course of transfer onto a printing medium;

FIG. 9 is a configurational view of an apparatus having means for heating a printing medium before transfer onto the printing medium;

FIG. 10 is an explanatory view showing a process for moving toner toward a printing medium by means of bias voltage;

FIG. 11 is a pair of explanatory views showing a material for the outermost surface of an intermediate transfer member;

FIG. 12 is an explanatory view showing a conventional melt transfer process;

FIG. 13 is a pair of explanatory views showing the conditions of transfer of a toner image onto a printing medium in a melt transfer process; and

FIG. 14 is a table showing numerical values used to draw the graph of FIG. 13(B).

### BEST MODE FOR CARRYING OUT THE INVENTION

The present invention will next be described with reference to an embodiment. In the below description, similar features are denoted by common reference numerals, and repeated description thereof may be omitted. An electrophotographic apparatus that uses a nonvolatile liquid developer employs an electrostatic transfer process, which is influenced by environmental factors, or a melt transfer process, which is not influenced by environmental factors.

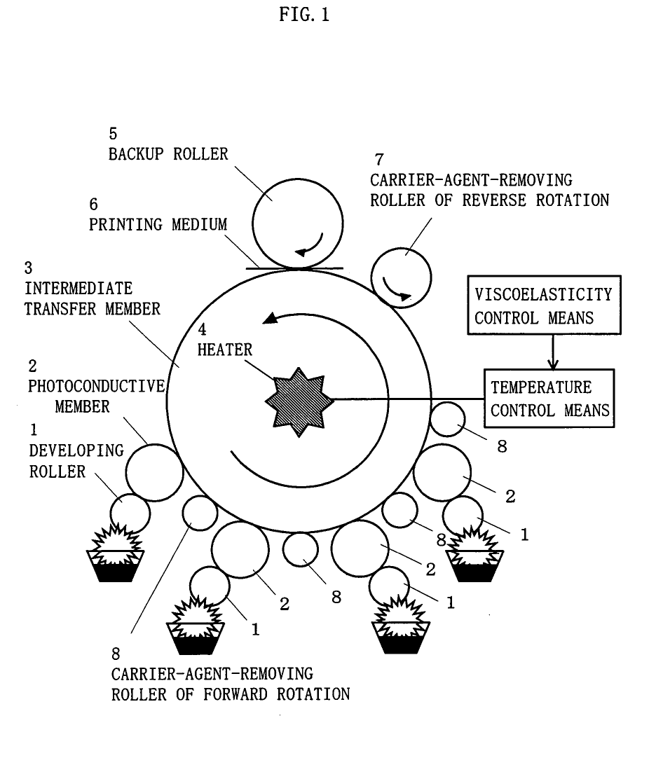

FIG. 1 exemplifies an electrophotographic apparatus that uses a nonvolatile liquid developer and employs a melt transfer process for transfer of a toner image onto a printing medium. In the example of FIG. 1, a photoconductive member 2 is provided for each of a plurality of colors and assumes the form of a drum having an insulator film whose electric resistance drops upon exposure. Each of the photoconductive members 2 is provided with, for example, a charger (not shown) for charging the photoconductive member 2, exposure means (not shown), such as LED, for exposing the photoconductive member 2, and a developing unit 1. The individual exposure means cause the formation of corresponding electrostatic latent images on the corresponding photoconductive members 2 with respect to a plurality of colors (for example, yellow, magenta, cyan, and black). The developing units 1 corresponding to the colors cause toner particles to adhere to the corresponding electrostatic latent images by use of electric field force, thereby forming toner images in the colors. The toner images in the colors are transferred onto an intermediate transfer member 3 and superposed on each other. A toner image resulting from the transferred toner images being superposed on each other is melted to a condition most suited for transfer by means of heating the toner image to a predetermined temperature by use of a heater 4 contained in the intermediate transfer member 3. The toner image in the molten condition is transferred onto a printing medium 6, such as paper, under subjection to pressure applied by a backup roller 5. The electrophotographic apparatus is configured and operates as does an ordinary electrophotographic apparatus.

As will be described in detail later, according to the configuration shown in FIG. 1, a carrier-agent-removing roller 7 of reverse rotation is provided on the intermediate transfer member 3 at a position located immediately before a position of transfer onto the printing medium 6; and carrier-agent-removing-rollers 8 of forward rotation are provided on the intermediate transfer member 3 at positions downstream of the corresponding photoconductive members 2.

The configuration shown in FIG. 1 includes viscoelasticity control means, which is a feature of the present invention, and temperature control means, which is controlled by the viscoelasticity control means and controls the temperature of a heater 4. The heater contained in the intermediate transfer member heats the intermediate transfer member to thereby heat a toner image formed on the surface of the intermediate transfer member.

The illustrated apparatus uses nonvolatile liquid developers and causes toners to adhere to corresponding electrostatic latent images formed on the corresponding photoconductive members by means of electric field force, thereby forming toner images on the corresponding photoconductive members. The viscoelasticity control means controls the viscoelasticity of a toner image formed of the toner images transferred from the photoconductive members onto the intermediate transfer member. The viscoelasticity is controlled such that, when the dynamic viscoelasticity of the toner image is measured at a forced vibration frequency of 1 Hz and an amplitude stress of 10 Pa, a storage modulus falls within a range of 1.0E5 Pa to 1.0E8 Pa, and a loss modulus falls within a range of 1.0E5 Pa to 1.0E8 Pa (E represents the power of 10; thus, E5=10⁵, and E8=10⁸). The below description refers to an example of controlling the heating of the intermediate transfer member for viscoelasticity control. However, the viscoelasticity of toner image particles can also be controlled by, in addition to temperature control, adjusting a carrier removal percentage as measured before transfer onto the printing medium or adjusting electric field force to be applied in the course of transfer onto the printing medium.

In the illustrated apparatus, a temperature of the liquid toner at which the above-mentioned requirement for a dynamic viscoelastic value is satisfied is obtained beforehand by preliminary measurement; and the viscoelasticity control means controls heating by the heater 4, which serves as heating means, in such a manner that the toner image on the intermediate transfer member (image-bearing member) is heated to the temperature before being transferred onto the printing medium.

The above heating temperature is controlled desirably such that the temperature of the image-bearing member (intermediate transfer member in the illustrated example) becomes not higher than the boiling point of the carrier agent and not higher than 100° C. This is to prevent the following problems: even the carrier agent that is nonvolatile at the room temperature volatilizes when the temperature of the image-bearing member becomes the boiling point of the carrier agent or higher, thereby affecting the human body; and when the image-bearing member is heated to an excessively high temperature, the image-bearing member is thermally damaged to thereby be deteriorated.

The heating of the image-bearing member is controlled as mentioned above to thereby heat the toner image on the image-bearing member to a predetermined temperature, whereby the above-mentioned requirement for a dynamic viscoelastic value is satisfied. Additionally, as will be described in detail later, the carrier agent is removed from the toner image by means of the carrier-agent-removing roller 7 of reverse rotation immediately before the toner image is transferred onto the printing medium.

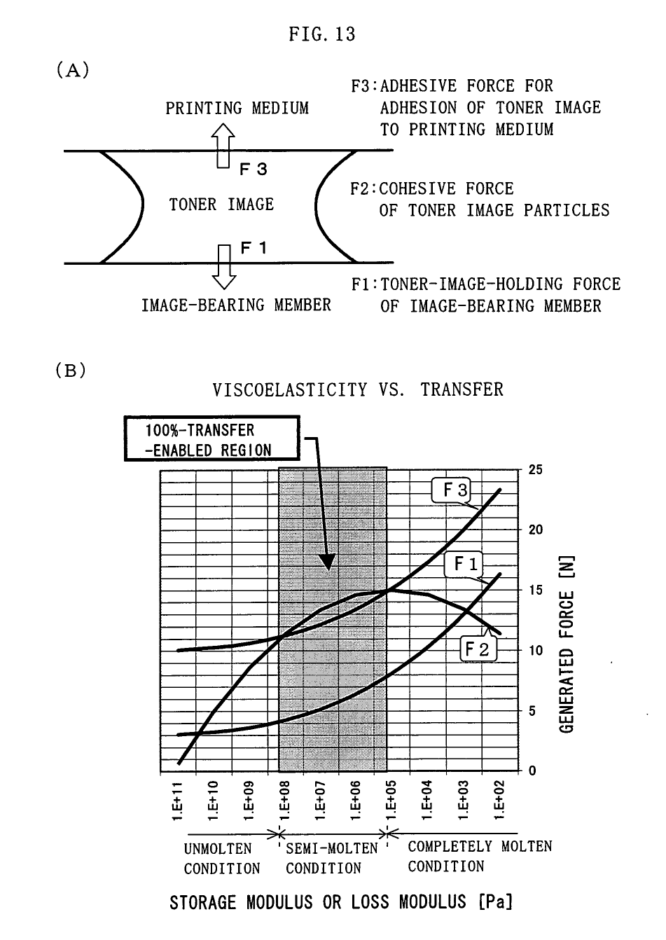

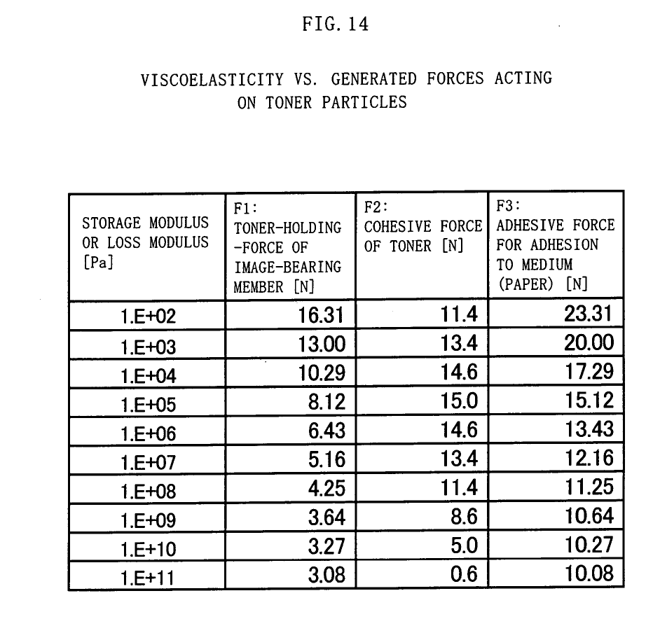

FIG. 13 is a pair of explanatory views showing the conditions of the transfer of the toner image onto the printing medium in a melt transfer process. FIG. 13(A) is a view explaining forces F1, F2, and F3; and FIG. 13(B) is a graph showing the results of measurement with respect to the relationship between transfer and the viscoelasticity (storage modulus or loss modulus) of toner particles. In FIG. 13(B), the horizontal axis represents the viscoelasticity of toner particles; and the vertical axis represents a generated force. Notably, storage modulus or loss modulus represented along the horizontal axis of the graph numerically decreases as melting progresses. Strictly, storage modulus and loss modulus must be represented separately. However, since they exhibited substantially the same tendency, the graph was drawn in a simplified manner. FIG. 14 is a table that shows numerical values used to draw the graph of FIG. 13(B) and numerically shows the relationship between storage modulus or loss modulus and the generated forces (F1, F2, and F3) acting on toner particles.

As shown in FIG. 13(A), when F1 represents a toner-image-holding force, F2 represents a cohesive force of toner image particles, and F3 represents an adhesive force for adhesion of the toner image onto the printing medium, the toner image can be transferred by 100% onto the printing medium if the relation F2>F3>F1 holds.

As is apparent from the results of measurement shown in FIG. 13(B), F1 and F3 increase as melting progresses. By contrast, F2 is a self cohesive force and increases for unification until melting progresses to a certain extent. However, F2 begins to decrease when melting progresses excessively. The relation F2>F3>F1 holds in the following case: when the dynamic viscoelasticity of the toner image transferred onto the image-bearing member is measured at a forced vibration frequency of 1 Hz and an amplitude stress of 10 Pa, both of storage modulus and loss modulus fall in a range of 1.0E8 Pa to 1.0E5 Pa. At this time, virtually 100% of the toner image can be transferred onto the printing medium. The viscoelasticity of toner particles represents the degree of the softening of toner particles (a resin component contained in the toner image) associated with the progress of the melting of toner particles and is influenced not only by the temperature of the toner image but also by the quantity of a carrier agent contained in the toner image. The degree of the softening of toner particles in the 100%-transfer-enabled region can be represented by the above-mentioned numerical values. More specifically, 100% of the toner image can be transferred when the toner particles of the toner image are in a semi-molten condition (may also be called a “liquid-toner-softened condition,” in which the toner particles are partially melted and are not melted to such an extent as to reach a completely molten condition.

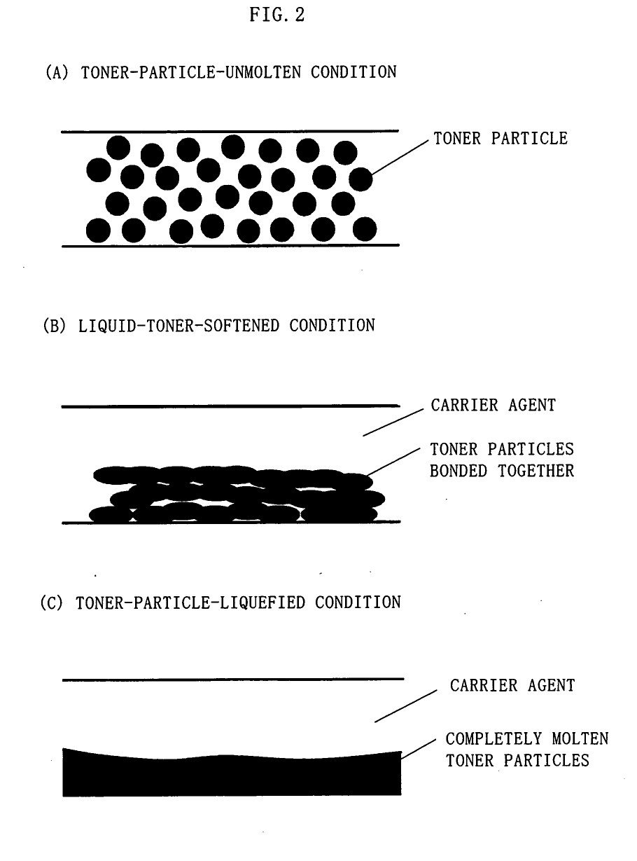

FIG. 2 is a series of views for explaining the molten conditions of the liquid toner. FIG. 2(A) shows a toner-particle-unmolten condition in which toner particles are dispersed in a carrier agent. The nonvolatile liquid developer employed in the present apparatus uses a nonvolatile silicone oil as a carrier agent. The viscosity of the silicone oil is 10 cSt to 200 cSt, preferably 50 cSt to 100 cSt. Toner particles formed from resin and pigment and having a size of about 1 μm to 2 μm are dispersed in the silicone oil at a percentage of 10% to 30%, preferably 10% to 20%. Notably, herein, the term “liquid toner” refers to a combined entity of a carrier agent and toner particles; and the term “toner image” refers to an assembly of toner particles in the form of an image.

FIG. 2(C) shows a completely molten condition of toner particles in a conventional melt transfer process. In the case where a nonvolatile liquid developer is used, a carrier agent, which is a carrier component of the liquid developer and is a dispersant, remains in a toner image even at the time of transfer of the toner image onto a printing medium, since the carrier agent is nonvolatile. When the carrier agent remains in a large quantity, the cohesive force F2 of toner image particles is weakened. Thus, before transfer, the carrier agent must be removed from the toner image to the greatest possible extent. In the conventional melt transfer process, as shown in FIG. 2(C), toner particles, which are a solid component of the liquid developer, are completely melted and unified. As a result, the carrier agent that is present in inter-toner-particle spacing and cannot be expelled by use of electric field force is forcibly expelled for removal.

As in the case of the conventional melt transfer process, it is known that melting of toner particles allows efficient removal of the carrier agent, which hinders transfer of the toner image onto the printing medium. However, in the conventional melt transfer process, as a result of toner particles being completely melted and unified, an adhesive force that causes the molten toner particles to adhere to an image-bearing member is generated. As a result of the molten toner particles sticking to the image-bearing member, the toner-image-holding force F1 of the image-bearing member increases. As a result, in some cases, the efficiency of transfer of the toner image onto the printing medium drops; and, after transfer, difficulty is involved in cleaning off residual toner particles from the image-bearing member.

FIG. 2(B) shows a liquid-toner-softened condition in the melt transfer of the present invention. In contrast to the conventional melt transfer in which toner particles are completely melted into a liquefied condition, according to the present invention, toner particles are partially melted and bonded into a liquid-toner-softened condition in which a carrier agent is present in inter-toner-particle spacing. Thus, the toner particles, which are a solid component of the liquid developer, are partially melted to thereby be softened, and are bonded to each other, whereby the toner particles are separated from the carrier agent, which is a liquid component of the liquid developer, and the removal of the carrier agent is facilitated. Accordingly, virtually 100% of the toner image can be transferred onto the printing medium.

As has been described with reference to FIG. 13(B), the liquid-toner-softened condition is the semi-molten condition in which toner particles are partially melted, but are not completely melted. The liquid-toner-softened condition corresponds to a viscoelastic range in which, when the viscoelasticity of the toner particles is measured under the above-mentioned conditions, both of storage modulus and loss modulus fall within a range of 1.0E5 Pa to 1.0E8 Pa.

As in the case of the toner-particle-liquefied condition in the conventional melt transfer, the liquid toner in a softened condition in the melt transfer of the present invention allows the carrier agent present in inter-toner-particle spacing to be removed satisfactorily. Additionally, since the toner particles are not melted to an unnecessarily intensive degree, the molten toner particles do not stick to the image-bearing member, so that the efficiency of transfer of the toner image onto the printing medium do not drop.

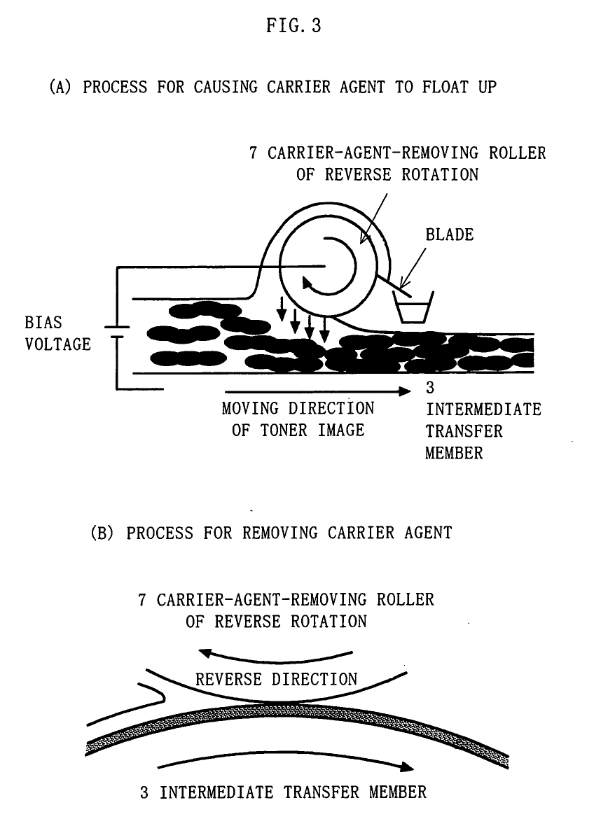

As mentioned above, the carrier-agent-removing roller 7 of reverse rotation shown in FIG. 1 is adapted to remove the carrier agent from the liquid toner that is in a softened condition and includes the carrier agent in inter-toner-particle spacing. The carrier-agent-removing roller 7 of reverse rotation will be further described with reference to FIG. 3. FIG. 3 is a pair of explanatory views showing a process for removing an unnecessary carrier agent. FIG. 3(A) shows a process for causing the carrier agent to float up; and FIG. 3(B) shows a process for removing the floating carrier agent. As shown in FIG. 3(A), bias voltage having the same polarity as that of a charge established on the toner particles is applied between the intermediate transfer member 3 and the carrier-agent-removing roller 7 of reverse rotation, thereby imposing electric field force on the charged toner particles. As a result, the toner particles are pressed against the surface of the intermediate transfer member 3, whereas the carrier agent is caused to float on the toner particles.

As shown in FIG. 3(B), the carrier-agent-removing roller 7 of reverse rotation is in contact with the floating carrier agent and removes the floating carrier agent. At this time, the carrier-agent-removing roller 7 of reverse rotation is caused to rotate in such a manner that its surface and the surface of the intermediate transfer member 3, which is in contact with the surface of the carrier-agent-removing roller 7 of reverse rotation via the liquid toner, move in opposite directions (this is herein called “reverse rotation”).

The carrier-agent-removing roller 7 of reverse rotation, which is caused to move in a direction opposite that in which the intermediate transfer member 3 moves, is rotated at such a rotational speed that its surface in the contact region moves at a speed equal to or higher than the moving speed of the toner image on the intermediate transfer member. By use of the carrier-agent-removing roller 7 of reverse rotation, an unnecessary carrier agent is removed. Thus, the carrier agent that is caused to float on the toner image by the above-mentioned electric field force can be removed almost completely. Such carrier removal is performed at least once on the toner image that is formed by superposing toner images in a plurality of colors on each other, immediately before the toner image is transferred onto the printing medium. The carrier agent that has moved from the intermediate transfer member 3 to the carrier-agent-removing roller 7 can be removed by use of, for example, a blade in contact with the surface of the carrier-agent-removing roller 7.

When the carrier agent floating on the toner image is removed, the carrier agent, which weakens an adhesive force for adhesion to the printing medium, is absent on the surface of the toner image having an adhesive force generated as a result of being melted. Thus, the adhesive force for adhesion to the printing medium is increased, thereby enabling consistent transfer.

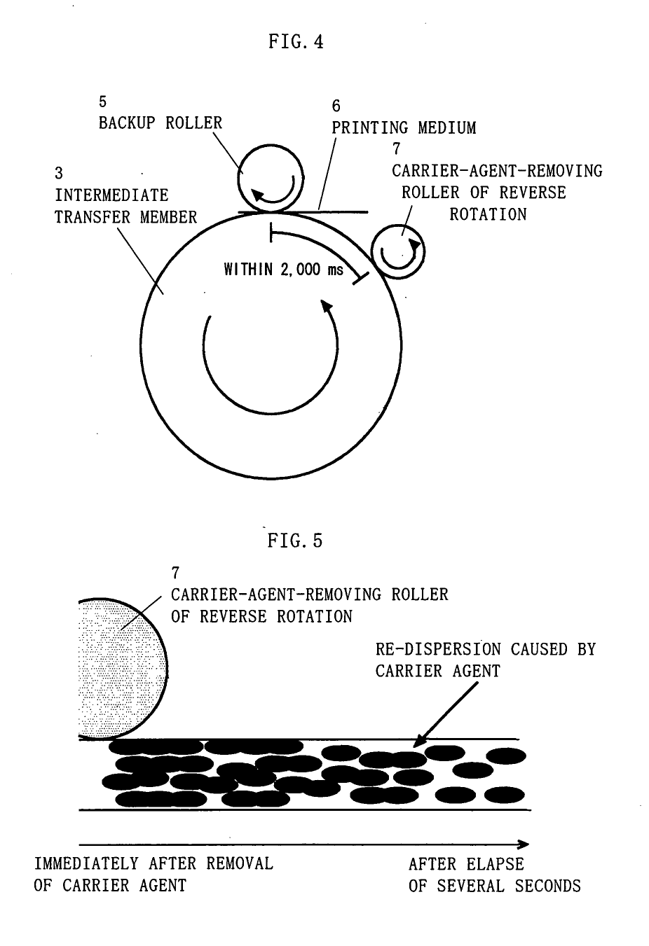

As shown in FIG. 4, the toner image is transferred onto the printing medium 6 within 2,000 ms after the carrier agent is removed by means of the carrier-agent-removing roller 7 of reverse rotation. In other words, the removal of the carrier agent is performed on the intermediate transfer member 3 at a position located immediately before the position of transfer.

The reason for the above-mentioned removal of the carrier agent immediately before transfer is as follows. As shown in FIG. 5, when a certain time elapses after the carrier agent floating on the toner image is removed by means of the carrier-agent-removing roller 7 of reverse rotation before transfer of the toner image onto the printing medium, a residual carrier agent causes the bonded toner particles to re-disperse. When the toner particles re-disperses, as time elapses, the carrier agent remaining in the toner image floats again on the toner image. As a result, the adhesive force F3 of the toner image for adhesion to the printing medium weakens, and the cohesive force F2 of toner image particles weakens, thereby hindering consistent transfer onto the printing medium.

When the toner image is to be transferred onto the printing medium after the carrier agent is removed in the liquid-toner-softened condition, in which the above-mentioned requirement for a dynamic viscoelastic value is satisfied, by means of the carrier-agent-removing roller 7 of reverse rotation, the solid content of the toner image on the intermediate transfer member is preferably rendered 50% to 95%. The carrier agent contained in the toner image weakens the cohesive force F2 of toner image particles at the time of transfer onto the printing medium, thereby hindering the transfer. Therefore, removing the carrier agent to the greatest possible extent is desirable. However, when the carrier agent is removed almost completely, the toner image is stuck to the image-bearing member, possibly resulting in a drop in the efficiency of transfer. Also, after transfer, difficulty may be involved in cleaning off residual toner from the image-bearing member. Thus, by means of removing the carrier agent contained in the toner image while the above-mentioned toner content range, which allows consistent transfer, is maintained, the toner image can be reliably transferred onto the printing medium, and the residual toner can be readily cleaned off from the image-bearing member.

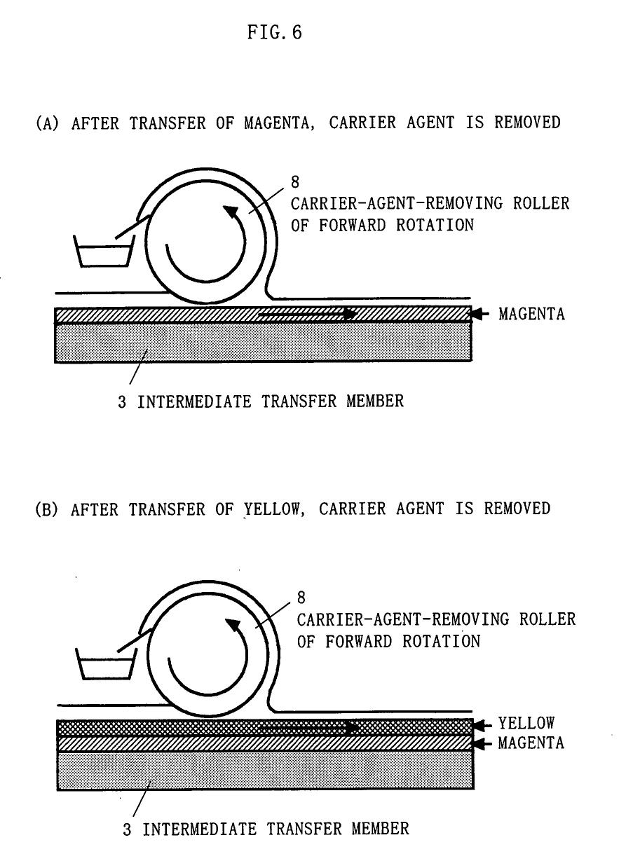

FIG. 6 is a pair of explanatory views showing a process for removing the carrier agent each time a toner image in each color is transferred. As has been described with reference to FIG. 1, in color printing, toner images in basic colors, such as yellow, magenta, cyan, and black, are superposed on each other on the intermediate transfer member so as to form a color toner image; and the color toner image is transferred onto the printing medium for printing. The carrier-agent-removing-rollers 8 of forward rotation are provided on the intermediate transfer member 3 at positions downstream of the corresponding photoconductive members 2 so as to remove the carrier agent each time the corresponding toner images in colors are transferred.

As shown in FIG. 6(A), for example, after a toner image in magenta, which is the first color, is transferred onto the intermediate transfer member 3, the carrier agent is removed; next, as shown in FIG. 6(B), after a toner image in yellow, which is the second color, is transferred onto the intermediate transfer member 3 in such a manner as to be superposed on the toner image in magenta, the carrier agent is removed. In this manner, each time a toner image in each color is transferred onto the intermediate transfer member 3, the carrier agent is removed. For the removal of the carrier agent to be performed each time a toner image in each color is transferred, the carrier-agent-removing-rollers 8 of forward rotation are provided. Each of the carrier-agent-removing-rollers 8 of forward rotation rotates in the same direction as the moving direction of the toner image on the intermediate transfer member 3 at such a rotational speed that both surfaces in the contact region move at the same speed. If a stationary blade or the like is used to remove an excess carrier agent, shearing force generated in association with the removal of the carrier agent may disturb the toner image, potentially resulting in an impairment in image quality. By virtue of using the above-described carrier-agent-removing-rollers 8 of forward rotation, generation of shearing force can be prevented in the course of the removal of the carrier agent. Therefore, the carrier agent can be removed without involvement of a disturbance of the toner image.

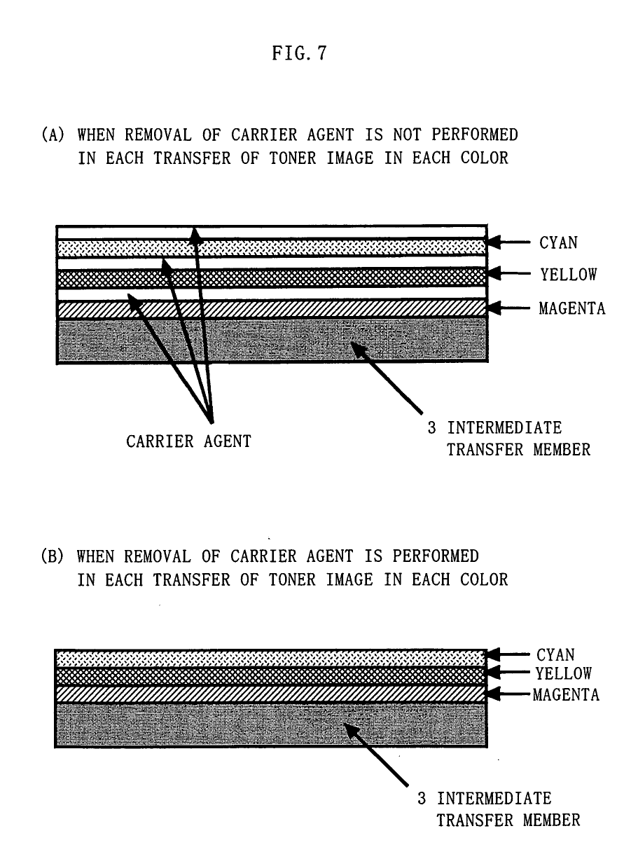

FIG. 7 is a pair of explanatory views showing the effect of the carrier-agent-removing process in color printing. A toner image in each color contains the carrier agent. After a toner image in a certain color is transferred onto the intermediate transfer member 3, if a toner image in the next color is superposed on the previous toner image without removal of the carrier agent, as shown in FIG. 7(A), the carrier agent is sandwiched between the toner images in colors. When the resultant toner image having inner carrier-agent layers formed therein is to be transferred onto the printing medium, removal of an excess carrier agent before transfer becomes difficult. The residual carrier agent tends to disturb toner images in colors, potentially resulting in an impairment in image quality.

Thus, by means of removing an excess carrier agent each time a toner image in each color is transferred onto the intermediate transfer member 3, a final color toner image resulting from the transferred toner images in colors being superposed on each other is free of excess remaining carrier agent, as shown in FIG. 7(B). Thus, an impairment in image quality, which could otherwise result from a disturbance of the toner image, can be prevented.

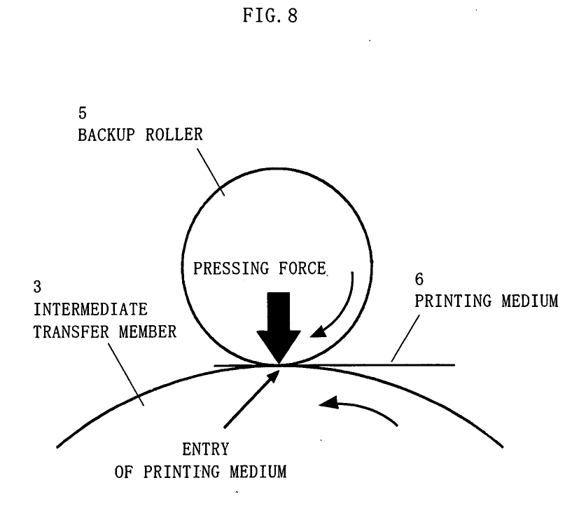

FIG. 8 is an explanatory view showing application of pressure by the backup roller in the course of transfer onto the printing medium. As shown in FIG. 8, in a transfer section where the toner image is transferred onto the printing medium 6, the backup roller 5 applies pressure. Preferably, the pressure at the time of transfer is controlled to be 0.5 MPa to 4.0 MPa. In the case where a nonvolatile liquid developer is used, application of pressure by use of the backup roller 5 in the course of transfer of the toner image can compensate for lack of the cohesive force F2 of toner image particles caused by the carrier agent. Thus, there can be maintained the relation required for consistent transfer “F2 (cohesive force of toner image particles)>F3 (adhesive force for adhesion to printing medium)>F1 (toner-image-holding force of image-bearing member).”

In the case of transfer in the conventional melt transfer process, the backup roller must apply excessively high pressure (4.0 MPa or greater) in order to compensate for the weakening of F2 (cohesive force of toner image particles) and F3 (adhesive force for adhesion to printing medium) caused by the carrier agent. This causes generation of vibration when the printing medium enters the transfer section, resulting in image noise. However, in the apparatus based on the present invention, the dynamic viscoelasticity of the toner image is controlled so as to establish the liquid-toner-softened condition, which is most suited for transfer. Thus, pressure to be applied in the transfer section can be set low, thereby preventing generation of image noise.

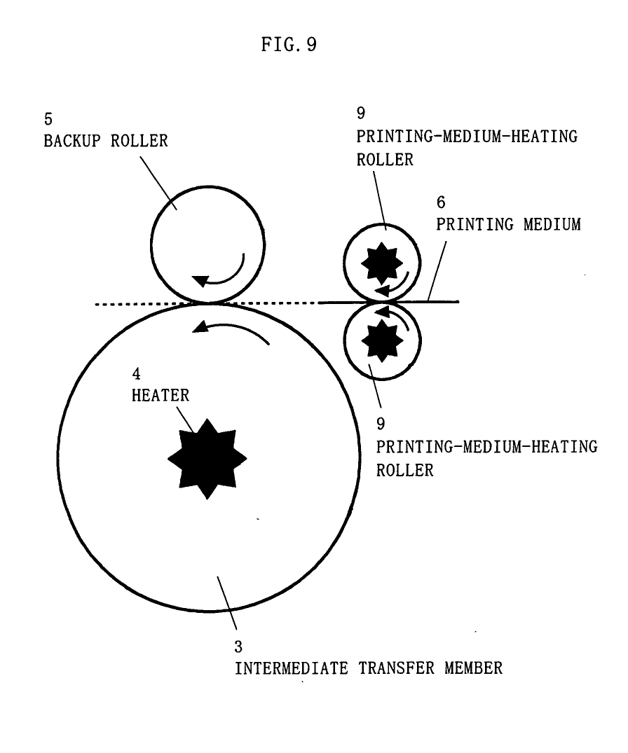

FIG. 9 is a configurational view of an apparatus having means for heating the printing medium before transfer onto the printing medium. As shown in FIG. 9, the printing medium onto which the toner image is to be transferred is heated beforehand by means of a pair of printing-medium-heating rollers 9. Preferably, the printing medium is heated to a temperature not lower than the temperature of the intermediate transfer member 3 (image-bearing member) and not higher than [(the lowest temperature at which the dynamic viscoelasticity of the toner image is such that the storage modulus is 1.0E5 Pa or less, and the loss modulus is 1.0E5 Pa or less)+50° C.]. Before the toner image is transferred onto the printing medium, the toner image is heated so as to assume a dynamic viscoelastic value most suited for transfer. However, when the toner image comes into contact with the printing medium, the temperature of the printing medium causes the temperature of the toner image to change, potentially causing the temperature of the toner image to fall outside a temperature range for assuming a dynamic viscoelastic value most suited for transfer. As a result, in some cases, consistent transfer may be hindered.

In order to cope with the above problem, the printing medium is heated beforehand such that, when the toner image comes into contact with the printing medium for transfer, the temperature of the toner image falls within a temperature range for assuming a dynamic viscoelastic value most suited for transfer.

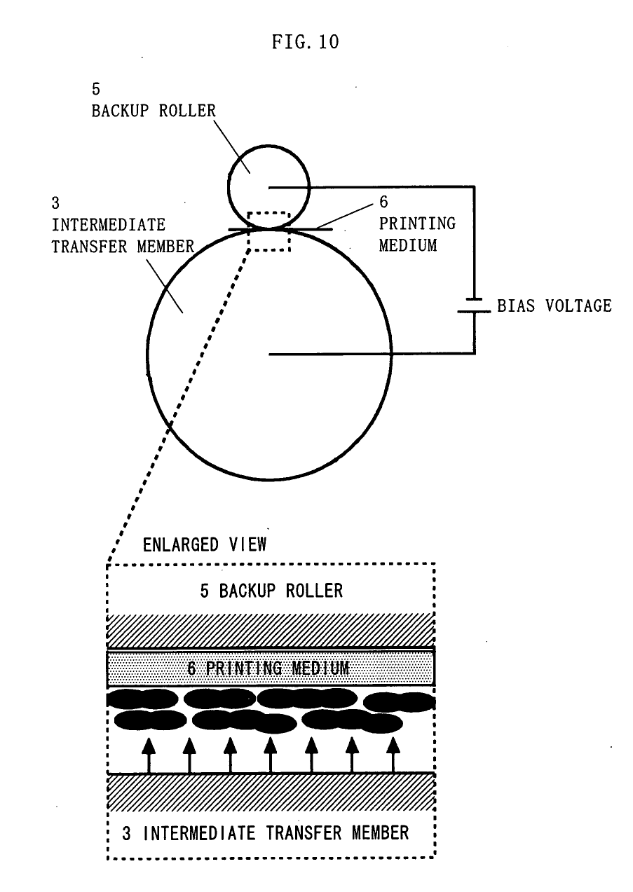

FIG. 10 is the explanatory view showing a process for moving toner toward the printing medium by means of bias voltage. In FIG. 10, a region encircled by the broken line is shown below in an enlarged condition. As shown in FIG. 10, when the toner image in the liquid-toner-softened condition, in which the toner image assumes a dynamic viscoelastic value most suited for transfer, is transferred onto the printing medium, bias voltage can be applied in such a direction as to move the toner image toward the printing medium. As described above, by means of causing the toner image to assume a dynamic viscoelastic value most suited for transfer, while a cohesive force of toner image particles and an adhesive force for adhesion to the printing medium are maintained at respective levels required for transfer, electric field force can be applied in such a direction as to move the toner image toward the printing medium. As a result, the toner-image-holding force of the intermediate transfer member 3 (image-bearing member) can be weakened, whereby the relation required for complete transfer “F2 (cohesive force of toner image particles)>F3 (adhesive force for adhesion to printing medium)>F1 (toner-image-holding force of image-bearing member)” can be reliably maintained.

In relation to the above-mentioned application of bias voltage, the electric resistance of the intermediate transfer member 3 is preferably 1.0E7 Ωcm to 1.0E10 Ωcm. In order to generate electric field force for moving the toner image on the intermediate transfer member 3 toward the printing medium, the intermediate transfer member 3 must have an electric resistance that falls within the above range. When the electric resistance of the intermediate transfer member 3 is too low, current flows to a portion of the intermediate transfer member 3 other than the toner image; therefore, in some cases, voltage is not applied to the toner image, resulting in a failure to generate sufficient electric field force. When the electric resistance of the intermediate transfer member 3 is too high, a voltage drop occurs on the intermediate transfer member 3; therefore, in some cases, sufficient voltage is not applied to the toner image, resulting in a failure to generate sufficient electric field force.

Thus, by means of setting the electric resistance of the intermediate transfer member 3 to the above-mentioned range, voltage is effectively applied to the toner image to thereby generate sufficient electric field force for transfer, so that transfer can be consistently performed.

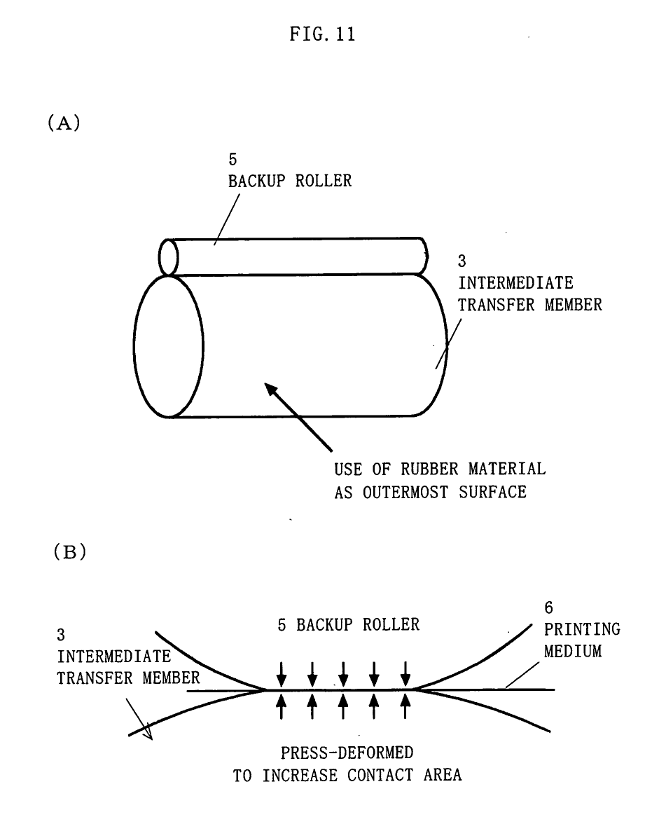

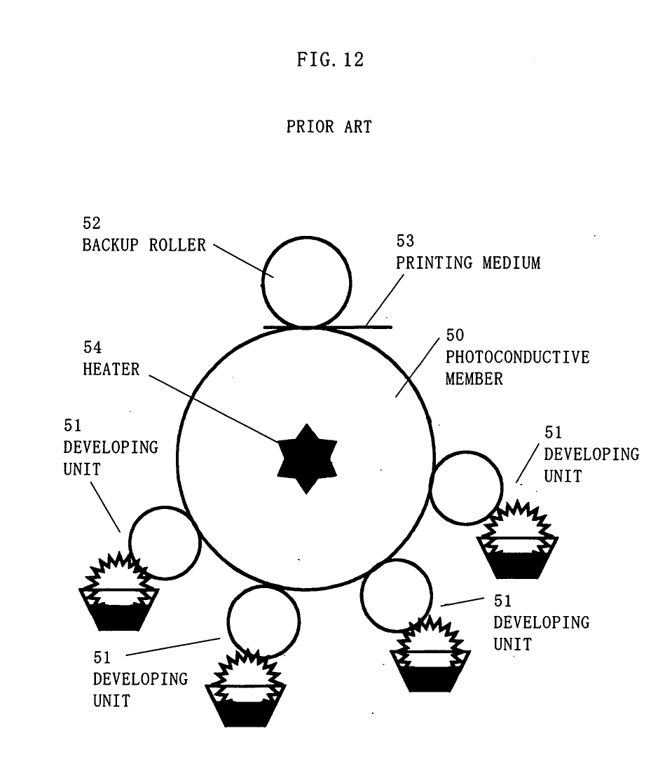

FIG. 11 is a pair of explanatory views showing a material for the outermost surface of the intermediate transfer member. FIG. 11(A) shows the intermediate transfer member 3 in contact with the backup roller 5; and FIG. 11(B) shows the contact region in an enlarged condition. Preferably, a rubber material of JIS-A 10 degrees to 80 degrees exhibiting high toner releasability is used to form the outermost surface of the intermediate transfer member 3, from which the toner image in the liquid-toner-softened condition, in which the toner image assumes a dynamic viscoelastic value most suited for transfer, is transferred onto the printing medium by use of the backup roller 5. Use of the material having high toner releasability can weakens the toner-image-holding force of the intermediate transfer member 3. As shown in FIG. 11(B), when pressure is applied from the backup roller 5 at the time of transfer, use of the rubber material allows deformation of the transfer section to thereby increase a contact area with the printing medium, thereby facilitating transfer and enabling consistent transfer.

As described above, according to the present invention, in the case of melt transfer by use of a nonvolatile liquid developer, toner particles are caused to enter the liquid-toner-softened condition, which is most suited for transfer of the toner image onto the printing medium. As a result, there can be reliably maintained the condition for enabling virtually 100% transfer of the toner image onto the printing medium; i.e., the relation “F2 (cohesive force of toner image particles)>F3 (adhesive force for adhesion of toner image to printing medium)>F1 (toner-image-holding force of image-bearing member).” Also, since there is no need to apply an excessively high pressure at the time of transfer, there can be provided a liquid-development electrophotographic apparatus that enables transfer with high image quality without occurrence of an image noise, such as a shock mark.

1. A liquid-development electrophotographic apparatus in which a toner image formed by developing a formed electrostatic latent image by use of a nonvolatile liquid developer is transferred from an image-bearing member onto a printing medium by a melt transfer process, comprising:
control means for controlling a viscoelasticity of a toner image on the image-bearing member by bonding toner particles of the toner image together by means of partially melting the toner particles, so as to cause the liquid toner to enter a softened condition having a carrier agent in inter-bonded-toner-particle spacing, the control means causing the bonded toner particles to be separated from the carrier agent without causing the toner particles to be melted to such an extent as to be liquefied; and
carrier-agent-removing means for removing the carrier agent from the viscoelasticity-controlled toner image, the carrier-agent-removing means having a surface in contact with the carrier agent caused to float by use of electric field force, and removing the carrier agent by moving the surface in a direction opposite a moving direction of the toner image.

2. A liquid-development electrophotographic apparatus according to claim 1, wherein the viscoelasticity of the toner image is controlled such that, when a dynamic viscoelasticity of the toner image is measured at a forced vibration frequency of 1 Hz and an amplitude stress of 10 Pa, a storage modulus falls within a range of 1.0E5 Pa to 1.0E8 Pa, and a loss modulus falls within a range of 1.0E5 Pa to 1.0E8 Pa.

3. A liquid-development electrophotographic apparatus according to claim 1, further comprising heating means for heating the toner image formed on the image-bearing member,
wherein the viscoelasticity of the toner image is controlled in such a manner that the heating means heats the toner image to a temperature at which the toner image exhibits a target dynamic viscoelastic value, which is determined on the basis of a previously measured relationship between heating temperature and the dynamic viscoelasticity of toner particles contained in the liquid developer to be used.

4. A liquid-development electrophotographic apparatus according to claim 3, wherein, when the toner image is heated, a temperature of the image-bearing member is controlled to a temperature lower than a boiling point of the carrier agent.

5. A liquid-development electrophotographic apparatus according to claim 1, wherein the carrier-agent-removing means is provided on the image-bearing member at a position located immediately before a position of transfer onto the printing medium; bias voltage is applied to the carrier-agent-removing means to thereby move charged toner particles of the toner image present on the image-bearing body and softened by the viscoelasticity control means toward the image-bearing body, to thereby cause the carrier agent to float on the charged toner particles; and the floating carrier agent is removed.

6. A liquid-development electrophotographic apparatus according to claim 5, wherein the carrier-agent-removing means removes the carrier agent in such a manner that, when the toner image is to be transferred onto the printing medium, a solid content of the toner image is 50% to 95%.

7. A liquid-development electrophotographic apparatus according to claim 1, wherein, in a transfer section where the toner image is transferred onto the printing medium, a pressure to be applied between the image-bearing member and a backup roller is set to 0.5 MPa to 4.0 MPa.

8. A liquid-development electrophotographic apparatus according to claim 1, further comprising a plurality of removing means for removing the carrier agent each time a toner image in each of a plurality of colors for color printing is transferred onto the image-bearing member,
wherein the removing means move in the same direction as a moving direction of the toner images on the image-bearing member.

9. A liquid-development electrophotographic apparatus according to claim 1, further comprising printing-medium-heating means for preheating the printing medium to a temperature equal to or higher than a temperature of the image-bearing member before transfer of the toner image onto the printing medium.

10. A liquid-development electrophotographic apparatus according to claim 1, further comprising means for applying bias voltage in such a manner that electric field force acts on the toner image in such a direction as to cause the toner image to move toward the printing medium in the course of transfer of the toner image onto the printing medium.

11. A liquid-development electrophotographic apparatus according to claim 10, wherein the means for applying the bias voltage applies the bias voltage between the image-bearing member and a backup roller; and the resistance of the image-bearing member is set to 1.0E7 Ωcm to 1.0E10 Ωcm.

12. A liquid-development electrophotographic apparatus according to claim 1, wherein a rubber material is used to form an outermost surface of the image-bearing member from which the toner image is transferred onto the printing medium.
